(19) United States
(12) Patent Application Publication
(10) Pub. No.: US 2016/0078312 A1
(43) Pub. Date: Mar. 17, 2016

(54) IMAGE PROCESSING METHOD AND APPARATUS USING TRAINING DICTIONARY

(71) Applicant: CANON KABUSHIKI KAISHA, Tokyo (JP)

(72) Inventor: Yoshinori Kimura, Utsunomiya-shi (JP)

(21) Appl. No.: 14/847,248

(22) Filed: Sep. 8, 2015

(30) Foreign Application Priority Data
Sep. 12, 2014 (JP) 2014-186153

(51) Int. Cl. G06K 9/62; G06T 7/00

(52) U.S. Cl. CPC G06K 9/627; G06K 9/6255; G06T 7/0081; G06T 2207/20021; G06T 2207/20081

(57) ABSTRACT

The image processing method extracts, from a first image, partial areas such that they overlap one another, and provides, by dictionary learning using model images corresponding to multiple types, a set of linear combination approximation bases and a set of classification bases to acquire classification identification values indicating the multiple types to which each partial area belongs. The method approximates the partial areas by linear combination of the linear combination approximation bases to acquire linear combination coefficients, sets the classification identification values by a linear combination of the classification bases and the linear combination coefficients, sets, for each pixel of the first image, one classification identification value from those set for two or more of the partial areas including that pixel, and produces the second image whose each pixel corresponds to that of the first image and has the one classification identification value.

### BACKGROUND OF THE INVENTION

1. Field of the Invention

The present invention relates to an image processing technique of classifying multiple object images included in an input image into multiple types.

2. Description of the Related Art

As the above-described image processing technique, Zhuolin Jiang, Zhe Lin and Larry S. Davis, “Learning a discriminative dictionary for sparse coding via label consistent K-SVD”, IEEE Conference on computer vision and pattern recognition, 2011, p. 1697-1704 (hereinafter referred to as “Document 1”) discloses a method of classifying a pattern present in an input image by producing a set of bases with dictionary learning using model images whose types are predetermined and approximating the pattern with a linear combination of a small number of the bases in the set. The types refer to categories, such as a person face and a flower, into which objects are classified.

Japanese Patent Laid-Open No. 2012-008027 discloses a method of classifying whether each of multiple patches (grid images) obtained by dividing an input image acquired through image capturing of a tissue sampled from an organ of a patient is a lesion tissue or not, depending on an amount of characteristic of each patch or on a comparison result between each patch and a cancer cell. This method divides the input image into the multiple patches such that an unextracted area which is not extracted as a patch remains in the entire input image and extracted patches do not overlap one another.

The classification method disclosed in Document 1 can classify the pattern solely present in the input image into one of the predetermined types, but cannot classify multiple objects (object images) present in the input image into the multiple types. Dividing the input image into the multiple patches in the same manner as that in the classification method disclosed in Japanese Patent Laid-Open No. 2012-008027 and applying, to each patch, the method disclosed in Document 1 enables classifying each object, but probably results in a low classification accuracy. The reason for this is that it is difficult to correct an erroneous classification for each patch and that a classification resolution cannot be higher than that of the divided patches. For a similar reason, the classification method disclosed in Japanese Patent Laid-Open No. 2012-008027 also provides a low classification accuracy for each patch.

### SUMMARY OF THE INVENTION

The present invention provides an image processing method and an image processing apparatus, each capable of classifying, with good accuracy, multiple object images included in an input image into multiple predetermined types.

The present invention provides as an aspect thereof an image processing method of classifying object images included in a first image into multiple types and producing a second image showing a result of the classification. The method includes: extracting, from the entire first image, multiple partial areas such that in the first image no area remains which is not extracted as the partial area and such that the partial area are allowed to overlap one another; providing, each as a set of bases produced by dictionary learning using model images corresponding to the respective types, a set of linear combination approximation bases to approximate the partial areas by linear combination and a set of classification bases to acquire classification identification values each indicating one of the multiple types to which each partial area belongs; approximating each of the partial areas by the linear combination of the linear combination approximation bases to acquire linear combination coefficients; setting the classification identification values corresponding to each of the partial areas by a linear combination of the classification bases and the linear combination coefficients; setting, for each of pixels of the first image, one classification identification value by using the classification identification value set for two or more of the partial areas each including that pixel; and producing the second image whose pixels corresponding to the pixels of the first image, each of the pixels of the second image having the one classification identification value as its pixel value.

The present invention provides as another aspect thereof a non-transitory computer-readable storage medium storing an image processing program as a computer program to cause a computer to execute an image process of classifying object images included in a first image into multiple types and producing a second image showing a result of the classification. The image process includes: extracting, from the entire first image, multiple partial areas such that in the first image no area remains which is not extracted as the partial area and such that the partial area are allowed to overlap one another; providing, each as a set of bases produced by dictionary learning using model images corresponding to the respective types, a set of linear combination approximation bases to approximate the partial areas by linear combination and a set of classification bases to acquire classification identification values each indicating one of the multiple types to which each partial area belongs; approximating each of the partial areas by the linear combination of the linear combination approximation bases to acquire linear combination coefficients; setting the classification identification values corresponding to each of the partial areas by a linear combination of the classification bases and the linear combination coefficients; setting, for each of pixels of the first image, one classification identification value by using the classification identification value set for two or more of the partial areas each including that pixel; and producing the second image whose pixels corresponding to the pixels of the first image, each of the pixels of the second image having the one classification identification value as its pixel value.

The present invention provides as still another aspect thereof an image processing apparatus configured to classify object images included in a first image into multiple types and to produce a second image showing a result of the classification. The image processing apparatus includes: an extractor configured to extract, from the entire first image, multiple partial areas such that in the first image no area remains which is not extracted as the partial area and such that the partial area are allowed to overlap one another; a memory configured to store, each as a set of bases produced by dictionary learning using model images corresponding to the respective types, a set of linear combination approximation bases to approximate the partial areas by linear combination and a set of classification bases to acquire classification identification values each indicating one of the multiple types to which each partial area belongs; an approximator configured to approximate each of the partial areas by the linear combination of the linear combination approximation bases to acquire linear combination coefficients; a classifier configured to set the classification identification values corresponding to each of the partial areas by a linear combination of the classification bases and the linear combination coefficients; a setter configured to set, for each of pixels of the first image, one classification identification value by using the classification identification value set for two or more of the partial areas each including that pixel; and a producer configured to produce the second image whose pixels corresponding to the pixels of the first image, each of the pixels of the second image having the one classification identification value as its pixel value.

Further features and aspects of the present invention will become apparent from the following description of exemplary embodiments with reference to the attached drawings.

### BRIEF DESCRIPTION OF THE DRAWINGS

FIG. 1 is a block diagram illustrating a configuration of an image processing apparatus which performs an image classification process that is an embodiment of the present invention.

FIG. 2 is a flowchart illustrating an operation of the image processing apparatus.

FIGS. 3A and 3B illustrate a result of Experimental Example 1 that performs the image classification process of the embodiment.

FIGS. 4A and 4B illustrate an example of linear combination approximation bases and linear combination coefficients acquired thereby.

FIGS. 5A and 5B illustrate an example of classification bases and a classification vector acquired thereby.

FIGS. 6A and 6B illustrate a training vector of “a person face” and a training vector of “a flower”, respectively.

FIG. 7 illustrates a result of a comparison between the image classification process of Embodiment and image classification processes by methods respectively disclosed in Japanese Patent Laid-Open No. 2012-008027 and Document 1.

FIG. 8 illustrates a result of Experimental Example 2 that performs the image classification process of the embodiment.

### DESCRIPTION OF THE EMBODIMENTS

Exemplary embodiments of the present invention will be described below with reference to the attached drawings.

### Embodiment 1

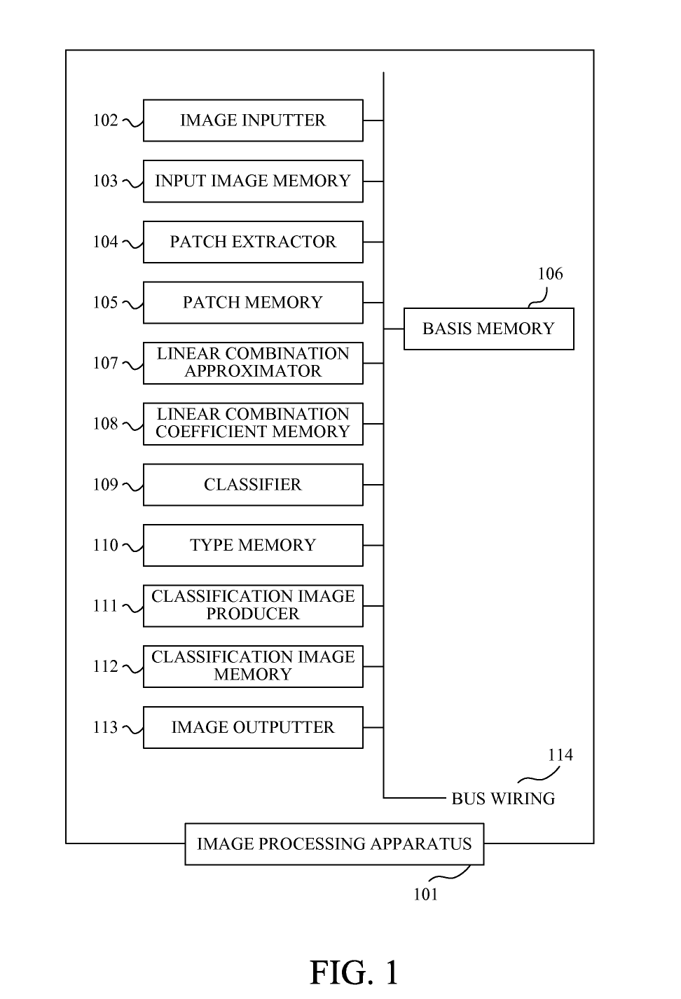

FIG. 1 illustrates a configuration of an image processing apparatus 101 which performs an image processing method (an image classification process) that is an embodiment of the present invention. The image processing apparatus 101 includes an image inputter 102, an input image memory 103, a patch extractor 104, a patch memory 105, a basis memory 106, a linear combination approximator 107 and a linear combination coefficient memory 108. The image processing apparatus 101 further includes a classifier 109, a type memory 110, a classification image producer (setter and producer) 111, a classification image memory 112 and an image outputter 113. The constituent elements from the image inputter 102 to the image outputter 113 are connected through a bus wiring 114, and their operations are controlled by a controller (not illustrated).

The image inputter 102 is constituted by an image capturing apparatus such as a digital camera or a slide scanner and provides an image (a first image; hereinafter referred to as “an input image”) produced by image capturing. The slide scanner performs image capturing of a pathological specimen used for pathological diagnosis. The image inputter 102 may be constituted by an interface apparatus such as a USB memory or an optical drive each capable of reading the input image from a storage medium such as a DVD or a CD-ROM. Alternatively, the image inputter 102 may be constituted by a multiple number of these devices.

The input image described in this embodiment is a color image having two-dimensional array data of luminance values for RGB colors. A color space showing the color image is not limited to such an RGB color space and may be other color spaces such as a YCbCr color space and an HSV color space.

The input image memory 103 temporarily stores the input image acquired by the image inputter 102.

The patch extractor 104 extracts, from the entire input image stored in the input image memory 103, multiple patches as partial areas. A method of extracting the patches will be described later.

The patch memory 105 associates the patches extracted by the patch extractor 104 with positions (hereinafter each referred to as “a patch extraction position”) where the patches are extracted. The patch memory 105 stores the patches and the patch extraction positions.

The basis memory 106 stores (provides) a set of bases (hereinafter referred to as “a basis set”) previously produced by dictionary learning using model images whose types are predetermined. The bases just referred to include linear combination approximation bases to approximate, by linear combination, the patches extracted from the input image and classification bases that return a classification identification value indicating one of the multiple predetermined types to which the patch extracted from the input image belongs (that is, indicating the type to which the patch belongs).

The types herein are categories used to classify objects such as a person face and a flower and may be freely set. It is even possible to set multiple types for objects of an identical type. For instance, the types may be set to classify objects present in a cell image used for pathological diagnosis into “a normal cell” and “an abnormal cell”. The dictionary learning using the above-described model images is performed for each of the types. The basis set and the classification identification value will be described in detail later.

The linear combination approximator 107 approximates each of the patches stored in the patch memory 105 by a linear combination of the linear combination approximation bases stored as basis elements in the basis memory 106 to acquire linear combination coefficients.

The linear combination coefficient memory 108 stores the linear combination coefficients acquired for each patch by the linear combination approximator 107.

The classifier 109 determines which one of the multiple types each of the patches belongs to, by using the classification bases stored in the basis memory 106 and the linear combination coefficients stored in the linear combination memory 108. That is, the classifier 109 classifies each patch into any one of the multiple types. Specifically, the classifier 109 sets the classification identification value for each patch by a linear combination of the classification bases and the linear combination coefficients. Thereafter, the classifier 109 stores the classification identification value set for each patch.

For each patch, the type memory 110 associates the patch extraction position stored in the patch memory 105 with the classification identification value set and stored by the classifier 109 and then stores these position and value.

The classification image producer 111 sets, depending on the patch extraction position and the classification identification value both stored in the type memory 110 for each patch, one classification identification value to be assigned to each position (that is, to each pixel) in the input image. Thereafter, the classification image producer 111 produces an output image whose pixels corresponding to the pixels of the input image each have the one classification identification value as a pixel value. The output image produced as just described is an image showing a result of the classification of the multiple object images included in the input image into the multiple predetermined types and is therefore referred to as “a classification image” in the following description.

The classification image memory 112 temporarily stores the classification image produced by the classification image producer 111.

The image outputter 113 is constituted by a display apparatus such as a CRT display or a liquid crystal display and displays the classification image stored in the classification image memory 112. Alternatively, the image outputter 113 may be constituted by an interface apparatus such as a CD-ROM drive or a USB interface to write the classification image to a storage medium such as a USB memory or a CD-ROM or may be constituted by a storage apparatus such as an HDD to store the classification image.

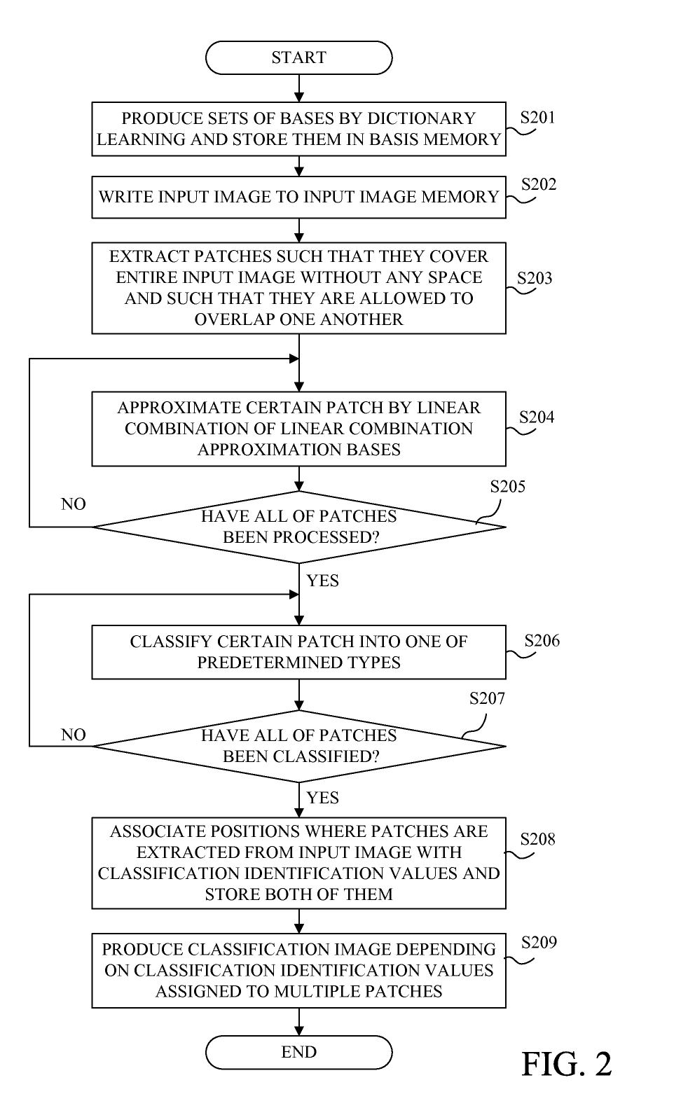

Next, description will be made of an operation of the image processing apparatus 101 of this embodiment with reference to a flowchart illustrated in FIG. 2. The image processing apparatus 101 is constituted by a computer such as a personal computer and a microcomputer and executes an image classification process (an image processing method) as an image process according to an image processing program that is a computer program.

First, at step S201, the image processing apparatus 101 produces the sets of bases by the above-described dictionary learning using the model image for each type and stores the sets of bases in the basis memory 106. The model images are provided by a user. The sets of bases include a set of N linear combination approximation bases each constituted by a small image having a pixel size of mxn and a set of N classification bases each constituted by a small image having a pixel size of m′xn′. All of m, m′, n, n′ and N are natural numbers. When any sets of bases are prestored in the basis memory 106, the stored sets of bases may be used for subsequent processes, with the dictionary learning at step S201 being omitted.

Next, at step S202, the image processing apparatus 101 (the image inputter 102) writes the input image to the input image memory 103. The input image is, for example, an 8-bit RGB image having two-dimensionally arrayed data. This embodiment converts the RGB image data into luminance data and uses the luminance data for subsequent processes.

Next, at step S203, the image processing apparatus 101 (the patch extractor 104) extracts, from the entire input image, multiple patches such that in the input image no area remains which is not extracted as the patch (in other words, the patches cover the entire input image without any space) and such that the patches are allowed to overlap one another. Thereafter, the image processing apparatus 101 associates the extracted patches with the patch extraction positions thereof in the input image and stores these patches and positions in the patch memory 105. As the patch extraction position, a center position of the patch, for example, may alternatively be stored.

A rule for extracting the patches from the input image such that the patches are allowed to overlap one another may be any rule; for example, a rule may be used which extracts the overlapped patches obtained by shifting each of mutually closest adjacent patches by one pixel in a horizontal or vertical direction. However, such a rule must be equally applied to the entire input image and must not be changed during the extraction.

Next, at step S204, the image processing apparatus 101 (the linear combination approximator 107) approximates, by using expression (1), one patch stored in the patch memory 105 with the linear combination of the linear combination approximation bases stored in the basis memory 106 to acquire the linear combination coefficients. Thereafter, the image processing apparatus 101 stores the linear combination coefficients in the linear combination coefficient memory 108.

$$Linear Combination Coefficient {\hat{α}}_{i} \\ {\hat{α}}_{i} = {argmin}_{{α}_{i}} {‖ {y}_{i} - D {α}_{i} ‖}_{2}^{2} s . t . {‖ {α}_{i} ‖}_{0} \leq T \qquad ( 1 )$$

In expression (1), yᵢ represents an i-th patch stored in the patch memory 105, and D represents the linear combination approximation bases stored in the basis memory 106. Furthermore, αᵢ represents the linear combination coefficients corresponding to the patch yᵢ, and T represents an upper limit of number of non-zero components contained in the linear combination coefficients αᵢ. Symbol ∥ ∥₂ represents an 12 norm expressed by following expression (2), and ∥α∥₀ represents an operator that returns the number of the non-zero components contained in the vector a. Symbol T represents a natural number sufficiently smaller than total number N of the linear combination approximation bases.

$${‖ X ‖}_{2} = \sqrt{{\sum }_{i} {\vert {x}_{i} \vert}^{2}} \qquad ( 2 )$$

In expression (2), X represents a vector or a matrix, and xᵢ represents an i-th component of X. In this embodiment, X shows an approximation error in the approximation of the patch extracted from the input image by the linear combination of the linear combination approximation bases. That is, the linear combination approximator 107 approximates, with good accuracy, the patches extracted from the input image by a linear combination of the bases whose number is smaller than the total number N of the linear combination approximation bases stored as the sets of bases by using expressions (1) and (2). The acquired linear combination coefficients include a small number of the non-zero components, which means that the coefficients are sparse.

At step S205, the image processing apparatus 101 checks whether or not the process at step S204 has been performed on all the patches stored in the patch memory 105. If determining that the process at step S204 has been performed on all of the patches, the image processing apparatus 101 proceeds to step S206. If not, the image processing apparatus 101 performs the process at step S204 on unprocessed patches.

The process at step S204 is to be performed on each individual patch and therefore may be performed alternatively by multiple distributed calculators on all of the patches. This alternative enables shortening a period of time required to perform the process at step S204 on all of the patches.

At step S206, the image processing apparatus 101 (the classifier 109) determines which one of the multiple predetermined types the one patch (hereinafter referred to as “a classification target patch”) stored in the patch memory 105 belongs to. Specifically, the classifier 109 first produces a classification vector by a linear combination of the classification bases stored in the basis memory 106 and the linear combination coefficients of the classification target patch stored in the linear combination coefficient memory 108; the linear combination is shown by following expression (3).

bᵢ=C\hat{α}ᵢ (3)

In expression (3), represents the classification bases, and bᵢ represents the classification vector of an i-th classification target patch stored in the patch memory 105. The other symbol is the same as that in expression (1). The classification vector is an index used to determine one of the above-described multiple types to which each of the classification target patches extracted from the input image belongs.

Next, the classifier 109 compares the produced classification vector with a training vector and sets, depending on a result of the comparison, the classification identification value indicating one of the multiple types to which the patch extracted from the input image belongs. For instance, when the predetermined types are “a person face” and “a flower” and a determination is made, from the comparison between the classification vector and the training vector of the patch extracted from the input image, that the patch belongs to “the person face”, the classifier 109 sets a classification identification value corresponding to the patch to “1”. The training vector is a vector datum as a reference used to determine the type to which the produced classification vector belongs and is previously given by the user in the dictionary learning. Although the training vector may be freely set by the user, it is necessary to set different training vectors for different types. Incidentally, the training vector (also called a training datum or a training set) is a term used in a field of machine learning.

The classifier 109 determines, by the above-described process, the type to which the classification target patch extracted from the input image belongs and shows a result of the determination as the classification identification value. The classification identification value set for each classification target patch is assigned not only to a representative pixel of the patch, but to all the pixels included in the patch.

At step S207, the classifier 109 checks whether or not the process at step S206 has been performed on all the patches stored in the linear combination coefficient memory 108. If determining that the process at step S206 has been performed on all of the patches, the classifier 109 proceeds to step S208. If not, the classifier 109 performs the process at step S207 on unprocessed classification target patches if not.

At step S208, the image processing apparatus 101 (the type memory 110) associates, for each patch, the patch extraction position with the set classification identification value and stores these position and value.

At step S209, the image processing apparatus 101 (the classification image producer 111) produces the classification image. The classification image is an image which has a size identical to that of the input image and whose all pixels have mutually identical initial values.

As described above, since the patches are extracted from the input image such that the patches are allowed to overlap one another, an identical pixel in the input image is included in two or more of the extracted patches. In this case, the classification image producer 111 sets one classification identification value to be assigned to the identical pixel included in the two or more patches in the input image, by using classification identification values of the two or more patches.

For instance, the one classification identification value may be set by a majority vote of the classification identification values of the two or more patches, that is, may be set to the classification identification value whose number is largest thereamong. When a majority vote result shows that a difference between the numbers of the respective classification identification values is equal to or less than a predetermined value, which makes it difficult to set the one classification identification value for the classification target patch, the classification target patch may be classified into “an unclassifiable type” (exceptional type), which means that the classification target patch belongs to none of the multiple types. A method of setting the classification identification value of the classification image by this majority vote is a characteristic part of this embodiment. Setting the classification identification value of the identical pixel included in the two or more patches by the majority vote of the classification identification values set for the two or more patches enables reducing number of erroneous classifications (that is, improving a classification accuracy) and avoiding a decrease in resolution of the classification image. Experimental Example 1 described below shows that image classification methods according to known methods provides a classification accuracy lower than that of this embodiment.

The classification image producer 111 produces a classification image whose pixels each have, as the pixel value, the one classification identification value set in this manner.

Alternatively, each classification identification value may be converted into color information specific thereto to assign mutually different kinds of color information to pixels whose classification identification values are mutually different. For instance, classification identification values set for the pixels in the classification image may be converted into an 8-bit gray scale image as a classification image to be finally output.

### Experimental Example 1

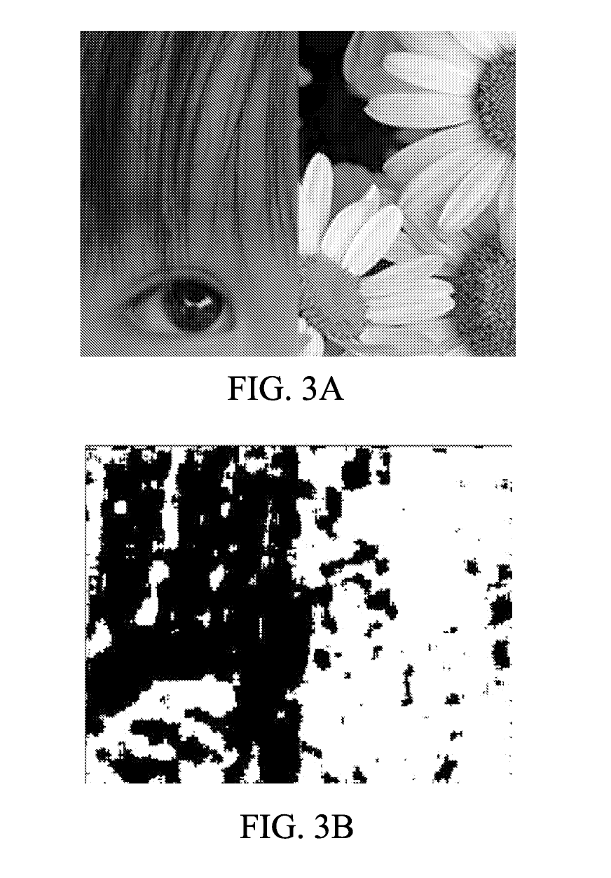

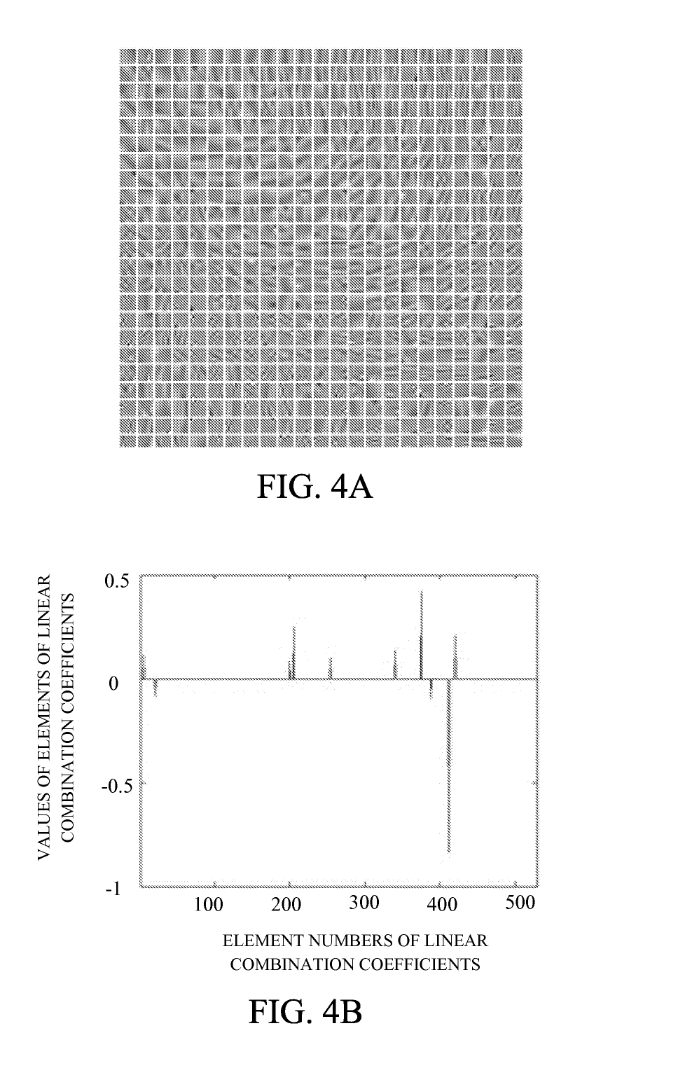

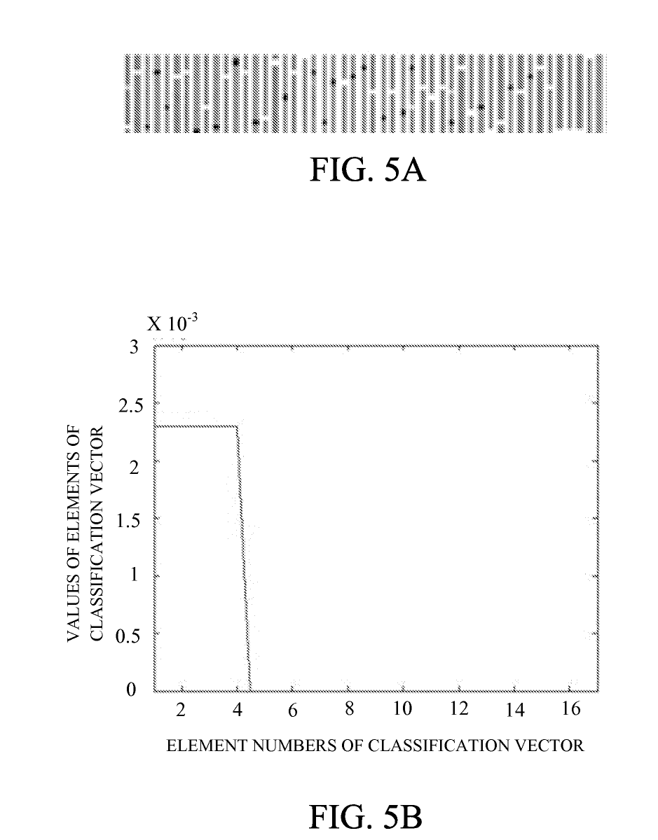

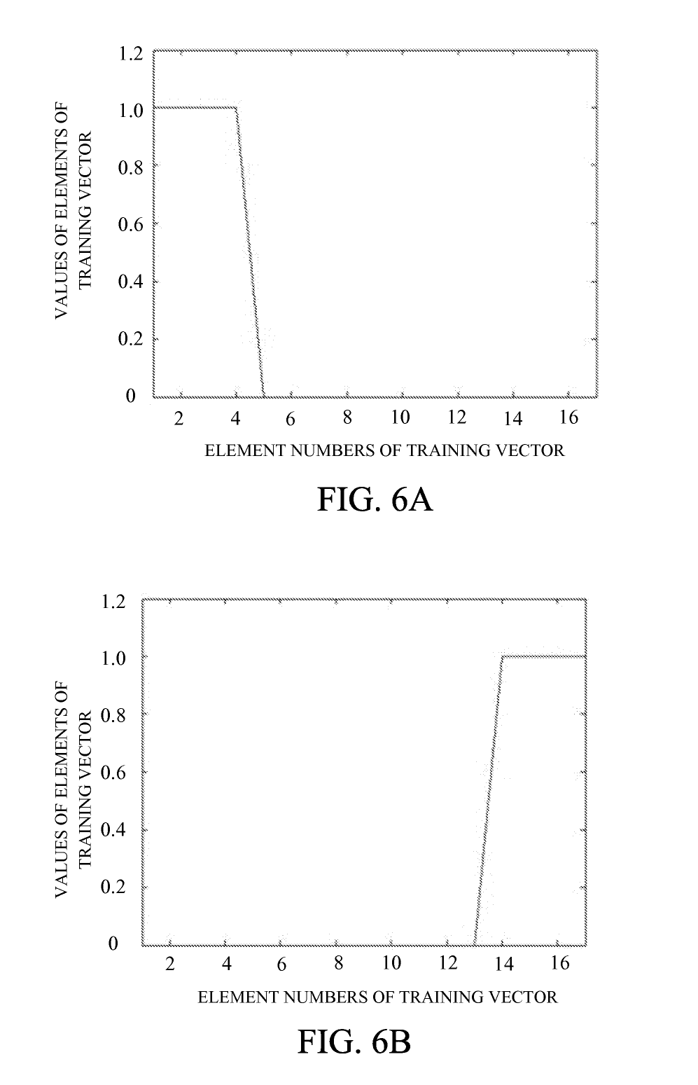

In this experimental example, object images included in the entire input image were classified into two types, “a person face” and “a flower”. FIG. 3A illustrates an input image whose left half part and right half part are respectively a person face image and a flower image. FIG. 3B illustrates a classification image provided as a result of performing the image classification process of the above-described embodiment. FIG. 4A illustrates N linear combination approximation bases used for an image classification process of this example. FIG. 4B illustrates an example of linear combination coefficients acquired in approximating patches extracted from the input image by a linear combination of linear combination approximation bases whose number is smaller than total number N of the linear combination approximation bases. FIG. 5A illustrates part of classification bases. FIG. 5B illustrates an example of a classification vector acquired from the classification bases. FIGS. 6A and 6B illustrate a training vector of “the person face” and a training vector of “the flower”, respectively.

In this experimental example, a size of each patch extracted from the input image is m×n=8×8 pixels. The linear combination approximation bases and the classification bases were produced so as to correspond to the objects to be classified by dictionary learning from model images of “the person face” and “the flower”. Total number N of each of the produced linear combination approximation bases and the produced classification bases is 529. The linear combination coefficients are given by a column vector having a size of 529×1 pixels.

In FIG. 4A, a total of 529 linear combination approximation bases each having the size of 8×8 pixels are arranged in a matrix of 23 rows and 23 columns. Of the 529 linear combination approximation bases, the linear combination approximation basis located at an i-th row and a j-th column corresponds to the linear combination coefficient whose element number in FIG. 4B is [23×(i−1)+j]. Multiplying the linear combination approximation bases by the linear combination coefficients respectively corresponding thereto and then adding results of the multiplications together enables approximating a certain patch included in the input image with good accuracy. The above-mentioned certain patch, for the linear combination coefficient illustrated in FIG. 4B specifically, is an upper left end patch in FIG. 3A having the size of 8×8 pixels. Mutually different patch extraction positions in the input image provide mutually different linear combination coefficients.

On the other hand, the classification bases are given by a column vector having a size of m′×n′=17×1 pixels, and the classification vector is a column vector having a size of 17×1 pixels. FIG. 5A illustrates horizontally arranged first 50 of the classification bases whose total number N is 529. A horizontal i-th classification basis in FIG. 5A corresponds to a linear combination coefficient whose element number in FIG. 4B is i. That is, multiplying the classification bases by the linear combination coefficients respectively corresponding thereto and then adding results of the multiplications together enables providing the classification vector illustrated in FIG. 5B. Comparing the classification vector to the training vectors illustrated in FIGS. 6A and 6B enables setting the classification identification values. Since the classification vector illustrated in FIG. 5B resembles the training vector of “the person face” illustrated in FIG. 6A, the patch having this classification vector is regarded as belonging to “the person face”, and thus the classification identification value corresponding to “the person face” is assigned to the patch.

In this experimental example, when a constant multiplication of the classification vector was performed to acquire a difference between the constant multiplication and the training vector, the training vector having the difference with a lower value is determined to resemble the classification vector more. The extraction of the patches from the input image was performed by raster scanning a patch extraction window having a size of 8×8 pixels while sequentially moving the patch extraction window by one pixel in the horizontal or vertical direction. However, the patch extraction window was moved so as not to protrude from the input image.

In the classification image, as color information, black was assigned to the pixels for which the classification identification value corresponding to “the person face” was set, and white was assigned to the pixels for which the classification identification value corresponding to “the flower” was set. In other words, mutually different classification identification values set for the pixels were converted into mutually different kinds of color information. Consequently, the left half part and the right half part of the classification image illustrated in FIG. 3B are mainly black and mainly white, respectively. This conversion also shows that the linear combination coefficients are sparse.

The inventor verified by an experiment that the image classification process can be accurately performed when number of non-zero components of the linear combination coefficients is about 2%. This means that, in approximating the patches extracted from the input image by the linear combination of the linear combination approximation bases, it is desirable to approximate the patches by the linear combination by using 2% (or around 2%) of the total number of the linear combination approximation bases.

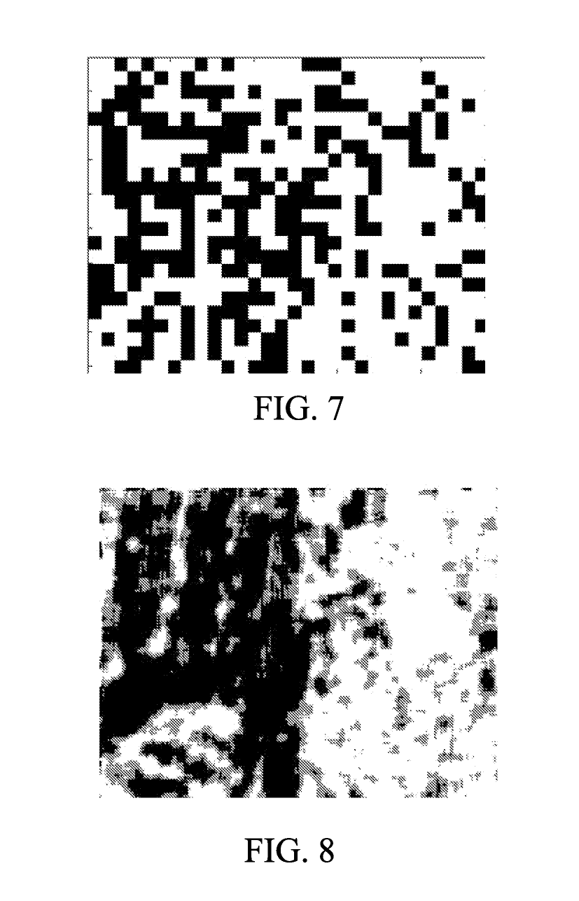

FIG. 7 illustrates a comparative example in which the input image was divided into multiple patches (grid images) by the method disclosed in Japanese Patent Laid-Open No. 2012-008027 and each divided patch was subjected to the image classification process by the method disclosed in Document 1. For purpose of comparison to Experimental Example 1, also in the comparative example, the size of each patch is set to 8×8 pixels, and the input image whose left half part and right half part are respectively the person face image and the flower image was used. Furthermore, the black was assigned to the pixels in the classification image classified into “the person face”, and the white was assigned to those classified into “the flower”.

A comparison between FIGS. 7 and 3B shows that a classification accuracy in the comparative example is lower than that in Experimental Example 1. Erroneous classification rates in Experimental Example 1 and the comparative example are about 20% and 52%, respectively. The erroneous classification rate was acquired by counting number of pixels to which one of the black and the white should be assigned but actually the other color is assigned and dividing the counted number by the total number of the pixels. Decreasing the size of each patch will probably increase a classification image resolution but decrease the classification accuracy.

As described above, this embodiment enables classifying, with good accuracy, the multiple object images included in the input image into the multiple predetermined types.

### Experimental Example 2

In Experimental Example, the object images included in the entire input image were classified into only the two types, “the person face” and “the flower”. However, the object images are not necessarily required to be classified into the two types and, as described at step 209, may alternatively be classified into “the unclassifiable type”. In this experimental example, one classification identification value for an identical pixel included in two or more of the patches extracted from the input image was set by a majority vote on the classification identification value set for the two or more patches. When the difference between the number of the classification identification values corresponding to “the person face” and the number of those corresponding to “the flower” is equal to or less than a predetermined value of 1% of the total number of the classification identification values participating in the majority vote, the object image concerned was classified into “the unclassifiable type”. However, the predetermined value as a threshold to be used to classify the object images into the unclassifiable type is not limited to 1% of the total number of the classification identification values participating in the majority vote and may be freely set.

As the input image, the image was used whose left half part and right half part are respectively the person face image and the flower image as in Experimental Example 1. The size of each patch extracted from the input image, the rule for extracting the patches, the linear combination approximation bases and the classification bases were identical to those in Experimental Example 1.

FIG. 8 illustrates a classification image provided by this experimental example. In the classification image, black, white and gray are respectively assigned to pixels each having the classification identification value corresponding to “the person face”, the pixels each having the classification identification value corresponding to “the flower” and the pixels classified into “the unclassifiable type”. In the classification image in FIG. 8, some of the pixels to which the white was assigned due to erroneous classifications in the left half part of the classification image in FIG. 3B, that is, the pixels not properly classified into “the person face” but erroneously into “the flower” are replaced by the gray pixels corresponding to “the unclassifiable type”.

The color information of the “unclassifiable type” pixel can be replaced by correct color information depending on color information of pixels surrounding the “unclassifiable type” pixel. For example, the gray pixel of the left half part of the classification image in FIG. 8 can be replaced by a black pixel. This replacement enables an improvement of a classification accuracy.

A background or the like as a third area that is neither “the person face” nor “the flower” may be classified into “the unclassifiable type”. Moreover, the third area may be classified into a new type.

The above-described embodiment enables producing a result image (a second image) showing the result of classifying, with good accuracy, the multiple object images included in the input image (a first image) into the multiple predetermined types.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-186153, filed on Sep. 12, 2014, which is hereby incorporated by reference wherein in its entirety.

What is claimed is:

1. An image processing method of classifying object images included in a first image into multiple types and producing a second image showing a result of the classification, the method comprising:
extracting, from the entire first image, multiple partial areas such that in the first image no area remains which is not extracted as the partial area and such that the partial area are allowed to overlap one another;
providing, each as a set of bases produced by dictionary learning using model images corresponding to the respective types, a set of linear combination approximation bases to approximate the partial areas by linear combination and a set of classification bases to acquire classification identification values each indicating one of the multiple types to which each partial area belongs;
approximating each of the partial areas by the linear combination of the linear combination approximation bases to acquire linear combination coefficients;
setting the classification identification values corresponding to each of the partial areas by a linear combination of the classification bases and the linear combination coefficients;
setting, for each of pixels of the first image, one classification identification value by using the classification identification value set for two or more of the partial areas each including that pixel; and
producing the second image whose pixels corresponding to the pixels of the first image, each of the pixels of the second image having the one classification identification value as its pixel value.

2. An image processing method according to claim 1, wherein the linear combination of the linear combination approximation bases is a linear combination of the linear combination approximation bases whose number is smaller than a total number of the linear combination approximation bases included in the set of the linear combination approximation bases.

3. An image processing method according to claim 2, wherein the number smaller than the total number of the linear combination approximation bases is 2% of the total number.

4. An image processing method according to claim 1, further comprising:
producing, by the linear combination of the classification bases and the linear combination coefficients, classification vectors for the multiple partial areas, the classification vector being an index to identify one of the multiple types to which each of the partial areas belongs; and
setting the one classification identification value for each of the partial area, depending on a result of a comparison between the classification vector and a training vector previously given.

5. An image processing method according to claim 1,
wherein the method sets, for each of the pixel of the first image, the one classification identification value by a majority vote of the classification identification values of the two or more partial areas each including that pixel.

6. An image processing method according to claim 5,
wherein the method classifies the pixel of the first image in which a difference between numbers of the respective classification identification values in the majority vote is equal to or less than a predetermined value, into a type other than the multiple types.

7. An image processing method according to claim 1,
wherein the method provides, to the pixels in the second image for which the classification identification values mutually different are set, mutually different kinds of color information.

8. A non-transitory computer-readable storage medium storing an image processing program as a computer program to cause a computer to execute an image process of classifying object images included in a first image into multiple types and producing a second image showing a result of the classification, the image process comprising:
extracting, from the entire first image, multiple partial areas such that in the first image no area remains which is not extracted as the partial area and such that the partial area are allowed to overlap one another;
providing, each as a set of bases produced by dictionary learning using model images corresponding to the respective types, a set of linear combination approximation bases to approximate the partial areas by linear combination and a set of classification bases to acquire classification identification values each indicating one of the multiple types to which each partial area belongs;
approximating each of the partial areas by the linear combination of the linear combination approximation bases to acquire linear combination coefficients;
setting the classification identification values corresponding to each of the partial areas by a linear combination of the classification bases and the linear combination coefficients;
setting, for each of pixels of the first image, one classification identification value by using the classification identification value set for two or more of the partial areas each including that pixel; and
producing the second image whose pixels corresponding to the pixels of the first image, each of the pixels of the second image having the one classification identification value as its pixel value.

9. An image processing apparatus configured to classify object images included in a first image into multiple types and to produce a second image showing a result of the classification, the image processing apparatus comprising:
an extractor configured to extract, from the entire first image, multiple partial areas such that in the first image no area remains which is not extracted as the partial area and such that the partial area are allowed to overlap one another;
a memory configured to store, each as a set of bases produced by dictionary learning using model images corresponding to the respective types, a set of linear combination approximation bases to approximate the partial areas by linear combination and a set of classification bases to acquire classification identification values each indicating one of the multiple types to which each partial area belongs;
an approximator configured to approximate each of the partial areas by the linear combination of the linear combination approximation bases to acquire linear combination coefficients;
a classifier configured to set the classification identification values corresponding to each of the partial areas by a linear combination of the classification bases and the linear combination coefficients;
a setter configured to set, for each of pixels of the first image, one classification identification value by using the classification identification value set for two or more of the partial areas each including that pixel; and
a producer configured to produce the second image whose pixels corresponding to the pixels of the first image, each of the pixels of the second image having the one classification identification value as its pixel value.
